(19) United States
(12) Patent Application Publication
(10) Pub. No.: US 2004/0111605 A1
(43) Pub. Date: Jun. 10, 2004

(54) Method for authenticating multiple channels within a single fibre channel link

(75) Inventor: Ralph O. Weber, Dallas, TX (US)

Correspondence Address: WONG, CABELLO, LUTSCH, RUTHERFORD & BRUCCULERI,, P.C., 20333 SH 249, SUITE 600, HOUSTON, TX, 77070, US

(73) Assignee: Brocade Communications Systems, Inc.

(21) Appl. No.: 10/352,890

(22) Filed: Jan. 28, 2003

Related U.S. Application Data
(60) Provisional application No. 60/432,289, filed on Dec. 10, 2002.

(51) Int. Cl. H04L 9/00

(52) U.S. Cl. 713/152

(57) ABSTRACT

Disclosed is a method for authenticating a Fibre Channel virtual Inter Switch Link comprised of two or more connections made over a TCP/IP network by establishing a first TCP/IP connection between a first Fibre Channel device and a second Fibre Channel device; authenticating this first TCP/IP connection using, for example SLAP; establishing a second TCP/IP connection; sending a nonce from the first Fibre Channel device to the second Fibre Channel device over said second TCP/IP connection; returning the nonce from the second Fibre Channel device to the first Fibre Channel device over the first TCP/IP connection using Switch ILS protocol; comparing the nonce sent over second TCP/IP connection from the first Fibre Channel device to the second Fiber Channel device to the nonce returned over the first TCP/IP connection from the second Fibre Channel device to the first Fibre Channel device; and, accepting the second TCP/IP connection as authenticated if the nonce that was sent is the same as the nonce that was returned.

### CROSS-REFERENCE TO RELATED APPLICATIONS

This application claims the benefit of U.S. Provisional Application No. 60/432,289 filed Dec. 10, 2002.

### BACKGROUND OF THE INVENTION

1. Field of the Invention

This invention relates to the Fibre Channel medium used for data transfer and storage. Fibre Channel provides a logical bi-directional, point-to-point connection between a host and a device. More particularly, it relates to a virtual Inter-Switch Link (ISL) created by mechanisms that allow the interconnection of islands of Fibre Channel storage area networks over IP-based networks to form a unified storage area network in a single Fibre Channel fabric. Fibre Channel over TCP/IP relies on IP-based network services to provide the connectivity between the storage area network islands over local area networks, metropolitan area networks, or wide area networks.

2. Description of Related Art

Authentication of a connection ensures a receiver that the sender is, in fact, who or what it purports to be. A connection using Transmission Control Protocol over Internet Protocol (“TCP/IP”) between two Fibre Channel devices, for example two Fibre Channel switches, may be authenticated using Fibre Channel Security Protocol (“FC-SP”) per the Fibre Channel Standard; “The American National Standard—Fibre Channel” as published by the American National Standards Institute (11 West 42nd Street, New York, N.Y. 10036) which is incorporated herein by reference.

Referring now to FIG. 1, there is shown hardware and a process for authenticating two switches; Switch A 101, the initiating switch, and Switch B 102, the responding switch. In this embodiment, the process is called SLAP, which is an acronym for Switch Link Authentication Protocol. On the left of FIG. 1, the process steps executed by Switch A 101 are shown. On the right, the process steps executed by Switch B are shown. In the middle, the instructions and payloads are represented.

SLAP is fully disclosed in commonly-owned U.S. patent application Ser. No. 10/062,853 filed Jan. 31, 2002, by James Kleinsteiber et al. entitled Node and Port Authentication in a Fibre Channel Network which is incorporated herein by reference.

The SLAP process may be used in some embodiments to authenticate a first TCP/IP link when using FCIP. In some embodiments, the SLAP is initiated by the port with the highest world-wide-name (“WWN”). WWNs are unique numbers used to identify ports in certain networking systems such as in a Fibre Channel network.

Referring to FIG. 1 and assuming that switch A 101's port has the higher WWN, switch A 101 may initiate a SLAP with Switch B 102. In doing so, switch A 101 will generate a random number. In some embodiments, that random number may be a nonce. A “nonce” is generally a non-repeating string freshly generated by the sender. In some embodiments, the nonce is obtained through a PKI call but it might also be obtained in any known manner, such as by implementing as a counter (a sequence number) or as a timestamp. For purposes of this example, whether a nonce, random number or other fact, the item will be designated as Ra, which generally indicates a random number generated by switch A 101 After generating Ra, switch A 101 stores Ra in a local memory. Any type of memory (DRAM, SRAM, optical, magnetic or otherwise) is sufficient although many embodiments use SRAM local to the engaged port. Switch A 101 then sends a SLAP Request instruction 104 to switch B 102. The payload with the instruction 104 is “Ra.”

Switch B 102 receives the instruction 104, and engages in the SLAP. First switch B 102 stores Ra in memory. Switch B 102 then generates its own fact, “Rb.” Switch B 102 then sends to Switch A, a SLAP Acknowledge instruction 106. The payload with SLAP Acknowledge 106 comprises: Rb; a copy of Ra signed with switch B 102's private key (“Sb(Ra)”); and switch B 102's certificate.

For illustrative purposes, this paragraph describes Switch B 102's actions in detail in order to more fully appreciate the interaction with Public Key Infrastructures (“PKI”). In signing Ra, switch B 102 creates a hash of Ra and then encrypts the hash using switch B 102's private key. In the case of the switch B's certificate (Cb), it comprises: switch B's public key; switch B's WWN (world-wide name); other information about switch B that is static (capable of being shipped with the switch); and a signed version of the data structure that comprises all of the foregoing three items—that is, a Root CA signed version of the Cb data-structure. Therefore, switch B 102 simply sends the signed version of its certificate that came from the root CA (with switch B 102's original certificate). Switch B 102 cannot create the signed portion of Cb because it is signed with the PRIVATE key of the Root CA (neither switch B nor any other entity should have access to the Root CA private key).

Referring again to FIG. 1, switch A 101 receives the SLAP Acknowledge instruction 106 and attempts to verify (in no necessary order) both Cb and switch B 102's signature. If either does not verify, then the SLAP ends and no communication between the ports will be allowed until a SLAP completes successfully. If both the certificate and the signature verify, then switch A 101 sends a SLAP_Confirm instruction 109 to switch B 102. The payload for the SLAP_Confirm instruction 109 comprises a signed version of Rb (“Sa(Rb)”) and Ca, which is switch A 101's certificate.

Once again for illustrative purposes, this paragraph will describe details of switch A 101's activity prior to sending the SLAP_Confirm 109. Switch A 101 will first attempt to verify Cb (the certificate) sent by switch B 102. To do so, switch A 101 first creates a hash of switch B 102's certificate. Second, switch A uses its copy of the Root CA public key to decrypt the signed copy of switch B 102's certificate. Third, switch A compares those two values. If the values are the same, then switch B 102's certificate is verified. This means that switch A 101 has indeed received a copy of switch B 102's authentic certificate. We know this because the certificate authority is trusted and a hash of switch B 102's certificate (as provided by switch B 102) was identical to the hash of switch B 102's certificate derived by decrypting a version signed by the Root CA. Next switch A 101 will attempt to confirm switch B's signature. To do this, first switch A creates a hash of the previously stored Ra. Second, switch A uses switch B 102's public key (just received) to decrypt the Sb(Ra). If the results of the first and second steps yield identical hash values, then switch B 102's signature is verified meaning switch B is what it says it is and that the SLAP_Acknowledge was certainly sent by switch B 102.

Referring back to FIG. 1, switch B 102 receives the SLAP_Confirm instruction 109 and then attempts to perform similar confirm operations. In particular, Switch B 102 attempts to verify Ca and switch A 101's signature. If either does not verify, then the SLAP terminates and the engaged ports will not be allowed to communicate. If the signature and Ca verify, then the SLAP is functionally complete and the two switches are functionally mutually authenticated. However, in order for switch A 101 to know the operation was successful there must be some indication from switch B 102. Referring to FIG. 1, that indication is the SLAP_Done 113 instruction sent from switch B 102 to switch A 101.

Yet again, for illustrative purposes the details of switch B 102's activities will be described for the time just prior to sending the SLAP_Done instruction 113. First, switch B 102 will attempt to verify the certificate Ca sent by switch A 101. To do so, switch B 102 first creates a hash of Ca. Second, switch B 102 uses its copy of the Root CA public key to decrypt the signed copy of switch A 101's certificate. Third, switch B 102 compares those two values. If the values are the same, then Ca is verified. This means that switch B 102 has indeed received a copy of switch A 101's authentic certificate. We know this because the certificate authority is trusted and a hash of switch A 101's certificate (as provided by switch A 101) was identical to the hash of switch A 101's certificate as derived by decrypting a version signed by the Root CA. Next switch B 102 attempts to confirm switch A 101's signature. To do this, first switch B 102 creates a hash of the previously stored Rb. Second, switch B 102 uses switch A 101's public key (just received) to decrypt Sa(Rb). If the results of the first and second steps yield identical hash values, then switch A 101's signature is verified meaning switch A is what it says it is and that the authentication confirm instruction was certainly sent by switch A.

While the SLAP protocol is secure, it is relatively time-consuming. It would be desirable to have a faster alternative method of authentication that could be used in certain circumstances.

### SUMMARY OF THE INVENTION

A first Fibre Channel over TCP/IP connection is authenticated using conventional methods—e.g., SLAP, as described above. When a request for a second (third, fourth, fifth, etc.) connection is made, the first, already authenticated connection is used to authenticate the second connection by returning a nonce transmitted over the second connection by the originating device. The nonce is returned by way of the authenticated connection using Switch Fabric Internal Link Services (SW_ILS)—link services that operate internal to the Fabric between switches—and compared with the nonce originally transmitted. If the nonce returned matches the nonce sent, the originating device may send an acceptance to the receiving device also using SW_ILS. Switch ILS frames are preferably transmitted using the FT-1 frame format via the Fibre Channel Class F service.

### BRIEF DESCRIPTION OF THE DRAWINGS

FIG. 1 shows hardware and a process for authenticating two Fibre Channel switches.

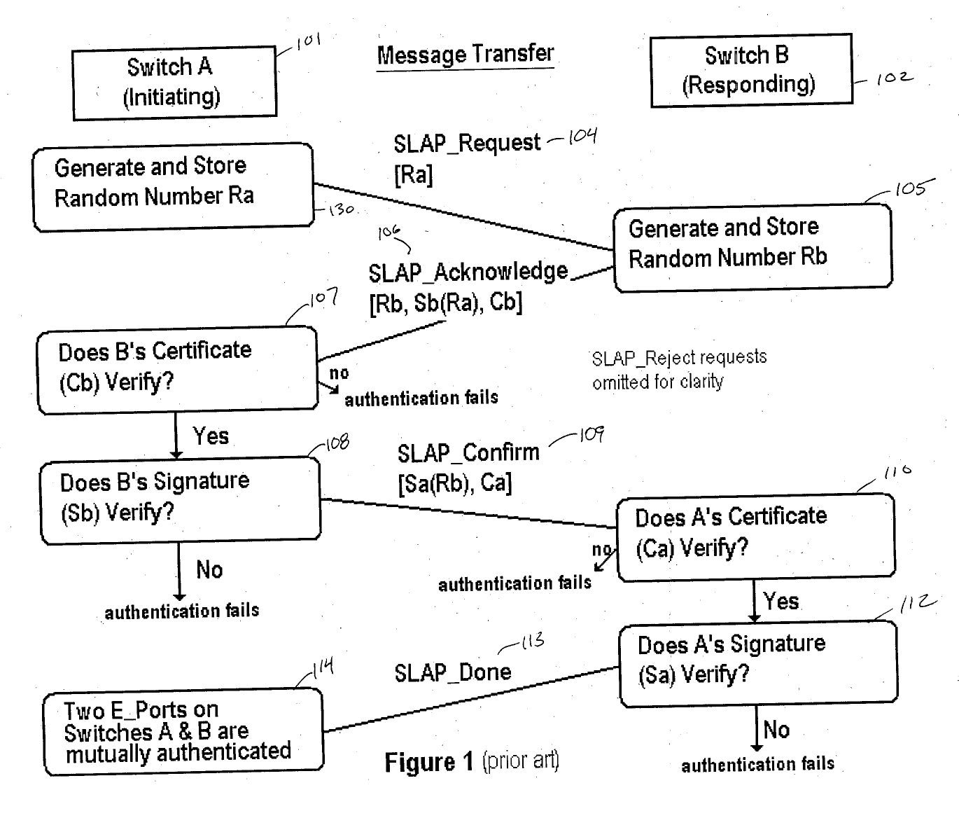

FIG. 2 shows two Fibre Channel devices connected by means of a virtual Inter Switch Link over an IP network.

FIG. 3 is a flowchart depicting the steps in one embodiment of the invention.

### DETAILED DESCRIPTION OF THE INVENTION

The Fibre Channel standards, available on the Internet at www.t11.org are incorporated herein by reference. Also incorporated herein by reference are the following working drafts “Fibre Channel over TCP/IP (FCIP)” dated August 2002 and available at http://www.ietf.org/internet-drafts/draft-ietf-ips-fcovertcpip-12.txt and “Fibre Channel Backbone (FC-BB-2)” Rev. 5.7 dated Aug. 30, 2002, and available at ftp://ftp.t11.org/t11//pub/fc/bb-2/02-283v2.pdf.

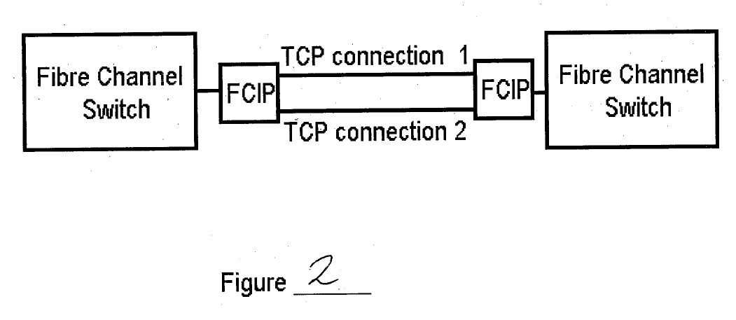

FIG. 2 is a block diagram of two Fibre Channel switches, each with an associated FCIP device which, in some embodiments, communicates with the Fibre Channel switch via a B_Port and with a network using TCP/IP protocol to create a virtual Inter Switch Link (ISL). The unqualified use herein of the term Virtual ISL refers to both VE_Port Virtual ISL and B_Access Virtual ISL. The TCP connections may be made over the Public Internet IP Network. It will be appreciated by those skilled in the art that the FCIP device may be incorporated within a Fibre Channel device such as a Fiber Channel switch.

As shown in FIG. 2, the bandwidth of the communications connection between two Fibre Channel devices using Fibre Channel over TCP/IP may be increased by adding a second (third, fourth, fifth, etc.) TCP/IP connection to the virtual ISL between the two devices. It is desirable that such secondary connections be authenticated. To avoid rerunning the full SLAP authentication protocol over all TCP connections, such authentication may be accomplished using the first, previously authenticated, connection.

One such method of authentication is to send a request for authentication over the secondary TCP/IP connection from the first device to the second device. The second device may then query the first device over the first, authenticated connection to determine whether the first device did, in fact, make a request for a second connection. If the first device replies with an indication that no such request was made, the second device may refuse the secondary connection.

A refinement of the above-described secondary connection authentication is to include a “nonce” in the request sent by the first device to establish a secondary TCP/IP connection. A nonce is a random number generated for one-time use in providing authentication. The second device may echo the nonce it received in the request for a secondary connection in its reply over the first, authenticated connection, in effect asking the first device whether it, in fact, sent the request for the particular secondary connection identified by the nonce. The first device may subsequently reply to the second device over the first, authenticated connection with an indication of whether the nonce matches the nonce it sent in its request to establish a secondary communications connection. If the nonce does not match, it may be assumed that the request was spurious or an attempted security breach.

As noted above, the authentication of a connection using SLAP typically requires six to eight round-trip communications between devices. Although it would be possible to use SLAP to authenticate the second (or subsequent) TCP/IP connection, that would be an unnecessary waste of system resources and would require more time to accomplish than the method disclosed herein.

The return of the nonce and the acknowledgement thereof may be advantageously performed using Switch Fabric Internal Link Services (SW_ILS)—link services that operate internal to the fabric between switches. Switch Internal Link Services are a set of switch-specific link services for configuring and managing the fabric address space. They are used within the fabric to configure fabric addresses and build and maintain routing tables. Switch internal link services use protocol type hex‘22’ in the type field of the frame header and follow normal Fibre Channel exchange and sequence management rules. The protocol consists of a request, or command sequence, and a reply sequence. The Routing Control (R_CTL) field in the frame header identifies the frame. It is a one-byte field in Word 0 Bits 31-24 that contains routing bits and information bits to categorize the frame function. The Routing Control field for a SW_ILS request is set to hex‘02’ (identifying a request) and the R_CTL for the response is set to x‘03’ (identifying a reply). The first byte of the first word in the payload of the first frame of the request or reply sequence contains the SW_ILS command or response code followed by three parameter bytes.

Typically, switch internal link services are sent by the Fabric Controller in one switch to the Fabric Controller in another switch and the source and destination address fields in the frame header of the request and reply are both set to the well-known address of the Fabric controller (hex‘FF FF FD’). The Fibre Channel standard requires each Fabric Controller to associate the switch internal link service with the correct E_Port to ensure proper routing. Routing is the process of transmitting frames toward the destination port.

Fibre Channel Class-1 service establishes a dedicated connection between two node ports and provides guaranteed in-order delivery of frames, full bandwidth, and deterministic latency for the duration of that connection. Even when an inter-switch link is involved in a Class-1 connection, the switches are still required to send supervisory traffic via the link. The Fibre Channel standard allows a switch to interject Class-F frames on the link, even during a Class-1 connection. When a gap between Class-1 frames is detected, a Class-F frame can be sent. If a Class-1 frame arrives, it is held in a temporary holding buffer until the Class-F frame completes.

Per the requirements of the Fibre Channel Switch Fabric—2 standard (working draft Rev. 5.3), all SW_ILS frames are to be transmitted using the FT-1 frame format via the Class F service. Class F Service is a connectionless service with notification of non-delivery between Interconnect_Ports. Class F service is used for control, coordination, and configuration of the fabric. Class F Service is defined by the Fibre Channel FC-SW-2 Standard for use by switches communicating across inter-switch links. Class F service multiplexes frames at frame boundaries. The service is used for control and coordination of the internal behavior of a Fibre Channel Swtiched Fabric.

A Class F Service is requested by an Interconnect_Port on a frame by frame basis. The fabric routes the frame to the destination Interconnect_Port. If an Interconnect_Port transmits consecutive frames to multiple destinations, the fabric demultiplexes them to the requested destinations. Class F delimiters are used to indicate the requested service and to initiate and terminate one or more Sequences as described in Fibre Channel Standard FC-PH. Class-F is based on a simplified model similar to Class-2. Class-F is typically used between switches to communicate fabric-related traffic on inter-switch links. The Fibre Channel standard requires switches to support Class-F operation on each E_Port. This ensures all switches can communicate with each other for supervisory traffic, even if they don't support the same user classes of service. Class-F frames may be routed via any available path. If more than one path exists between the sender and receiver, individual frames in a series of frames may be routed via different paths.

Class F frames use the Frame_Header defined in Clause 18 of Fibre Channel Standard FC-PH. The Start_of_Frame Fabric (SOFf) delimiter precedes the frame content of all Class F frames. The Data Field size of all Class F frames is less than or equal to 256 bytes prior to the successful completion of Exchange Link Parameters. All Class F frames include the CRC defined in Clause 17 of Fibre Channel Standard FC-PH. The End_of_Frame Normal (EOFn) delimiter immediately follows the CRC of all normally completed Class F Data frames and all normally completed Class F Link_Control frames except the last frame of a Sequence. The End_of Frame Terminate (EOFt) delimiter immediately follows the Cyclic Redundancy Check (CRC) of all Class F Link_Control frames that indicate the last frame of a Sequence which is normally terminated. The CRC is a four byte field that immediately follows the Data Field and is used to verify the data integrity of the Frame_Header and Data Field. A Class F frame is preceded and followed by Primitive Signals as defined in Fibre Channel Standard FC-PH. Class F service generally takes precedence over other Fibre Channel communications in the queue. The processor of a processor-based system—e.g., a Fibre Channel switch—may be used to process Class F service requests by the invocation of an appropriate subroutine call.

The R_CTL header field of a SW_ILS frame is set to hex‘02’ for a request frame and to hex‘03’ for a reply frame. The CS_CTL header field is set to hex‘00’. The D_ID and S_ID header fields are set for the specific SW_ILS desired. And, the TYPE field is set to hex‘22’, indicating Fibre Channel Fabric Switch Services. All other fields are set as appropriate according to the rules defined in Fibre Channel Standard FC-FS. The first word in the payload specifies the Command Code.

In one embodiment of the present invention, a new SW_ILS Command Code is assigned. This command code is Authenticate Special Frame (ASF).

In Fibre Channel Standard FC-SW-3 (Rev 6.1 dated Sep. 27, 2002), SW_ILS Command Code 28 xx xx xx is reserved for FC-BB-2 use.

When an FCIP entity receives a TCP Connect request that will result in the addition of a new TCP connection to an existing FCIP Link and its associated Virtual ISL, the FCIP entity may generate a request to the FC entity to authenticate the new TCP connection with the following information:

Connection nonce;

Destination FC Fabric Entity World Wide Name;

Connection Usage Flags; and,

Connection Usage Code.

The FC Entity may respond to the FCIP Entity indicating whether the new TCP connection is authentic. One criterion for authenticity is the success of an Authenticate Special Frame Switch Internal Link Service (ASF SW_ILS).

When the ASF SW_ILS is used to authenticate new TCP connections, all TCP connections in a Virtual ISL may be authenticated wither via FC-SP mechanisms—e.g., SLAP, described above or using the ASF SW_ILS or another equivalent authentication mechanism for other than the first TCP connection.

To authenticate a new TCP connection using the ASF SW_ILS, the FC Entity may use the information provided by the FCIP Entity to transmit an ASF request on the Virtual ISL to which the new TCP connection is being added. The format of the ASF Request payload may, in one particular embodiment, be as follows:

A 4-byte field containing hex ‘28 03 00 00’ to identify the ASF request sequence;

An 8-byte field for the destination FC Fabric Entity World Wide Name;

An 8-byte field for the connection nonce;

A 1-byte field for Connection Usage Flags;

A 1-byte field reserved for future use;

A 2-byte field for the Connection Usage Code; and

A 4-byte field reserved for future use.

An FC Entity that receives an ASF SW_ILS may verify that the information in the request payload identifies a TCP connection initiated by that FC/FCIP Entity pair. If a TCP connection initiated by the FC/FCIP Entity pair is identified by the ASF payload, the FC Entity may respond with an ASF Accept Payload signal (SW_ACC). The format of the ASF Accept payload may, in one particular embodiment, be as follows:

A 4-byte field containing hex ‘02 00 00 00’ to identify the Accept (SW_ACC) reply sequence; and,

An 8-byte field reserved for future use.

If the ASF payload does not identify a TCP connection initiated by the FC/FCIP Entity pair, the FC Entity may respond with an SW_RJT with a Reason Code of “Unable to Perform Command Request” and a Reason Code Explanation of “Class F Service Parameter Error.”

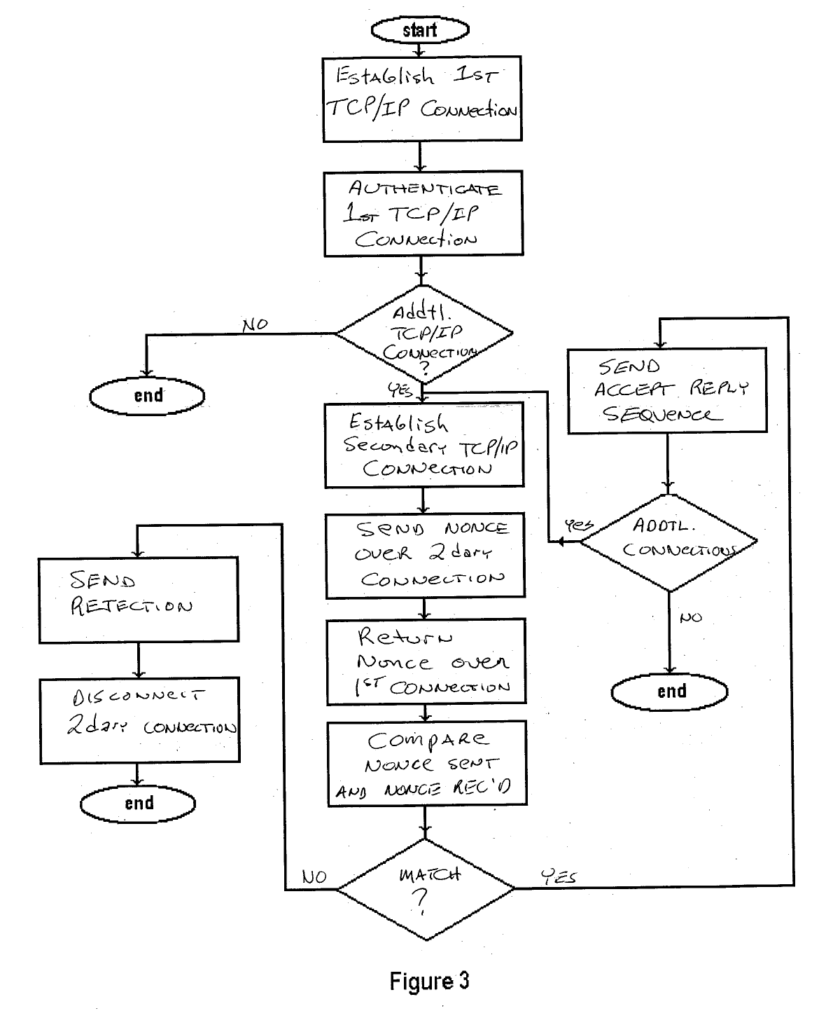

The steps of one particular method of authenticating a Fibre Channel over TCP/IP connection between a first device and a second device is illustrated as a flow chart in FIG. 3 wherein a first Fibre Channel over TCP/IP connection between a first device and a second device is established at 302. Both the first device and the second device may be FC/FCIP entities. This first connection is authenticated at 304. In some embodiments, this authentication may be accomplished by means of mechanisms described in Fibre Channel Standard FC-SP. One such mechanism is SLAP, described above. If an additional TCP connection on an existing link is desired, as indicated by the “Y” branch of decision diamond 306, a secondary TCP/IP connection is created at block 308 along with a request that the FC Entity authenticate the source of TCP connect request, providing the following information to the FC Entity for authentication purposes: Source FC Fabric Entity World Wide Name; Source FC/FCIP Entity Identifier; and Connection Nonce. The Connection Nonce is transmitted over the newly-established secondary TCP/IP connection at block 310.

The nonce received by the second device is returned to the first device over the first, authenticated connection using Switch Fabric Internal Link Services using the ASF SW_ILS as shown at block 312. The nonce sent at block 310 is then compared at block 314 to the nonce returned over the previously authenticated connection. If, as shown at branch “Y” of decision diamond 316, the nonce returned matches the nonce sent, an acceptance is sent over the first, authenticated connection as shown at block 320. The acceptance may also be sent in the form of a Switch ILS Authenticate Special Frame (ASF). If, as shown at branch “N” of decision diamond 316, the nonce returned does not identify a TCP connection initiated by the FC/FCIP Entity pair, the first device (FC Entity) may respond with a rejection signal such as an SW_RJT with an appropriate reason code and/or reason code explanation. The switch internal link service reject (SW_RJT) notifies the originator of an SW_ILS command that the command has been rejected. The second word of the SW_RJT payload may contain a reason code and explanation indicating why the switch internal link service was rejected. In response, the secondary connection may be terminated as shown at block 318 and an error report may be generated, as shown at block 322.

If tertiary, quaternary, etc. TCP connections are desired (the “Y” branch of decision diamond 324), the process may be repeated, beginning at block 308. In such a case, any previously-authenticated connection may be used to return the nonce (block 312) and the Accept Reply Sequence (e.g., SW_ACC).

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method of authenticating a Fibre Channel over TCP/IP connection between a first device and a second device in which a first connection is established and authenticated and a second connection is subsequently established and a nonce is sent from the first device to the second device over the second connection and the nonce is returned from the second device to the first device over the first, authenticated connection, compared to the nonce sent by the first device to the second device and an acceptance is sent over the first, authenticated connection from the first device to the second device if the nonce sent is the same as the nonce received wherein the improvement comprises:
returning the nonce received by the second device to the first device over the first, authenticated connection using Switch Fabric Internal Link Services; and,
sending the acceptance over the first, authenticated connection from the first device to the second device using Switch Fabric Internal Link Services.

2. A method of authenticating a Fibre Channel over TCP/IP connection between a first device and a second device which comprises:
establishing a first Fibre Channel over TCP/IP connection between the first device and the second device;
authenticating the first connection;
establishing a second Fibre Channel over TCP/IP connection between the first device and the second device;
sending a nonce from the first device to the second device over the second connection;
returning the nonce received by the second device to the first device over the first connection using Switch Fabric Internal Link Services;
comparing the nonce sent to the nonce returned; and,
sending an acceptance over the first, authenticated connection from the first device to the second device using Switch Fabric Internal Link Services if the nonce sent is the same as the nonce received.

3. A method as recited in claim 2 wherein authenticating the first connection is accomplished by means of the Fibre Channel Switch Link Authentication Protocol.

4. A method as recited in claim 2 wherein sending an acceptance comprises sending a Switch Accept switch internal link service command.

5. A method as recited in claim 2 further comprising sending a rejection over the first, authenticated connection from the first device to the second device using Switch Fabric Internal Link Services if the nonce sent is not the same as the nonce received.

6. A method as recited in claim 5 wherein sending a rejection comprises sending a Switch Internal Link Service Reject command.

7. A method as recited in claim 5 further comprising sending a reason code from the first device to the second device using Switch Fabric Internal Link Services.

8. A method as recited in claim 7 further comprising sending a reason code explanation from the first device to the second device using Switch Fabric Internal Link Services.

9. A method as recited in claim 2 further comprising sending a rejection over the first, authenticated connection from the first device to the second device using Switch Fabric Internal Link Services if a nonce was not sent by the first device to the second device.

10. A Fibre Channel switch comprising a processor and a medium storing instructions for causing the processor to:
establish a first Fibre Channel over TCP/IP connection between the switch and a second switch;
authenticate the first connection;
establish a second Fibre Channel over TCP/IP connection between the switch and the second switch;
send a nonce to the second switch over the second connection;
receive the nonce returned by the second switch over the first connection using Switch Fabric Internal Link Services;
compare the nonce sent to the nonce returned; and,
send an acceptance over the first, authenticated connection to the second switch using Switch Fabric Internal Link Services if the nonce sent is the same as the nonce received.

11. A switch as recited in claim 10 further comprising stored instructions for causing the processor to send a rejection over the first, authenticated connection to the second switch using Switch Fabric Internal Link Services if the nonce sent is not the same as the nonce received.

12. A switch as recited in claim 11 further comprising stored instructions for causing the processor to send a reason code over the first, authenticated connection to the second switch using Switch Fabric Internal Link Services if the nonce sent is not the same as the nonce received.

13. A switch as recited in claim 12 further comprising stored instructions for causing the processor to send a reason code explanation over the first, authenticated connection to the second switch using Switch Fabric Internal Link Services if the nonce sent is not the same as the nonce received.

14. A Fibre Channel device comprising a processor and a medium storing instructions for causing the processor to:
establish a first Fibre Channel over TCP/IP connection between the device and a second Fibre Channel device;
authenticate the first connection;
establish a second Fibre Channel over TCP/IP connection between the device and the second Fibre Channel device;
send a nonce to the second Fibre Channel device over the second connection;
receive the nonce returned by the second Fibre Channel device over the first connection using Switch Fabric Internal Link Services;
compare the nonce sent to the nonce returned; and,
send an acceptance over the first, authenticated connection to the second Fibre Channel device using Switch Fabric Internal Link Services if the nonce sent is the same as the nonce received.

15. A Fibre Channel device as recited in claim 14 further comprising stored instructions for causing the processor to send a rejection over the first, authenticated connection to the second Fibre Channel device using Switch Fabric Internal Link Services if the nonce sent is not the same as the nonce received.

16. A Fibre Channel device as recited in claim 15 further comprising stored instructions for causing the processor to send a reason code over the first, authenticated connection to the second Fibre Channel device using Switch Fabric Internal Link Services if the nonce sent is not the same as the nonce received.

17. A Fibre Channel device as recited in claim 16 further comprising stored instructions for causing the processor to send a reason code explanation over the first, authenticated connection to the second Fibre Channel device using Switch Fabric Internal Link Services if the nonce sent is not the same as the nonce received.

18. A Fibre Channel device comprising a processor and a medium storing instructions for causing the processor to:
communicate with a second Fibre Channel device using a first Fibre Channel over a TCP/IP connection between the device and the second Fibre Channel device;
respond to a request to authenticate the first connection;
establish a second Fibre Channel over TCP/IP connection between the device and the second Fibre Channel device;
receive a nonce from the second Fibre Channel device transmitted via the second connection;
return the nonce received from the second Fibre Channel device over the first connection using Switch Fabric Internal Link Services; and,
receive a signal over the first connection from the second Fibre Channel device using Switch Fabric Internal Link Services indicating whether the nonce returned was the same as the nonce sent by the second Fibre Channel device.
